(19) United States
(12) Patent Application Publication
(10) Pub. No.: US 2007/0117078 A1
(43) Pub. Date: May 24, 2007

(54) Celestial compass

(75) Inventors: Donald Bruns, San Diego, CA (US); David Sandler, San Diego, CA (US); Mikhail Belenkii, San Diego, CA (US)

Correspondence Address: TREX ENTERPRISES CORP., 10455 PACIFIC COURT, SAN DIEGO, CA, 92121, US

(73) Assignee: Trex Enterprises Corp

(21) Appl. No.: 11/604,133

(22) Filed: Nov. 24, 2006

Related U.S. Application Data
(60) Provisional application No. 60/739,350, filed on Nov. 23, 2005.

(51) Int. Cl. G09B 27/00

(52) U.S. Cl. 434/284

(57) ABSTRACT

A celestial compass. The celestial compass includes a camera with a wide angle lens suitable for viewing a large portion of the sky and a many-pixel sensor for collecting images of celestial objects such as stars, planets, the moon and the sun. The compass also includes a computer programmed with an (1) astronomical algorithm for providing the precise position of celestial objects based on precise input of time (date and time of day) and observation position (latitude and longitude), (2) celestial navigation software and (3) coordinate transformation software to correct distortion, convert pixel image data to astronomical coordinates and determine the instruments azimuth. The system includes provisions for the input of precise time and location information.

The present invention claims the benefit of Provisional Patent Application Ser. No. 60/739,350, filed Nov. 23, 2005.

### BACKGROUND OF THE INVENTION

The precise location of a target, viewed from an observation position on or near the surface of the earth can be made with the measurement of three coordinates; elevation (i.e. the direction of the vertical of the observation position, azimuth (i.e. the horizontal direction to the target, and range (i.e. the distance to the target). Elevation at the observation position can easily be found by using an inclinometer. Inclinometers with accuracies of about 10 micro-radians are available from suppliers such as Jewell Instruments with offices in Manchester, N.H. The cost of these inclinometers typically are in the range of about $2,000. Range can be determined with a laser rangefinder. Laser rangefinders with accuracies in the range of about 1 meter are available from suppliers such as Ratheon and the cost of these instruments is in the range of about $5,000. The true azimuth position is more difficult, if high precision is required. Magnetic compasses are typically accurate to only one degree, and the presence of steel or other local disturbances will often reduce accuracy to several degrees. Therefore, if positioning of a target depends on the use of a magnetic compass, substantial position errors would likely result.

The position of celestial objects at any time at any place on earth is known with extremely high accuracy. These celestial objects include all recognizable stars and planets, the sun and the moon. Celestial objects also include visible man-made satellites. Computer programs with astronomical algorithms are available that can be used to calculate the positions of any of these celestial objects at anytime for any position on or near the surface of the earth. Star pattern recognition computer programs are available in the prior art.

Accurate positioning of the celestial objects depends only on a precise knowledge of the latitude and longitude position and on the date and the precise time of observation. Latitude and longitude generally can be determined easily with precision of less than one meter with available maps or with global positioning equipment. These computer programs are described in several good text books including Astronomical Algorithms by Jean Meeus, published by Willmann-Bell with offices in Richmond Va. Techniques for using the programs to determine the positions of the celestial objects are clearly described in this reference. Programs such as these are used to provide planetarium programs such as “The Sky” available from Software Bisque and “Guide” available from Project Pluto.

Fisheye lenses are lenses with a highly curved protruding front that enables it to cover a solid angle of about 180 degrees. It provides a circular image with barrel distortion.

In many situations knowledge of the true azimuth to a target with precision of much better than 1 degree is needed. What is needed is a device that can measure the true azimuth to within about 1/10th to 1/20th of a degree.

### SUMMARY OF THE INVENTION

The present invention provides a celestial compass. A preferred embodiment includes a camera a wide angle lens suitable for viewing almost an entire hemisphere of the sky and a 6-million pixel sensor for collecting images of celestial objects such as stars, planets, the moon and the sun. The compass also includes a computer programmed with an (1) astronomical algorithm for providing the precise position of celestial objects based on precise input of time (date and time of day) and observation position (latitude and longitude), (2) celestial navigation software and (3) coordinate transformation software to correct distortion, convert pixel image data to astronomical coordinates and determine the instruments azimuth. The system includes provisions for the input of precise time and location information.

A wide angle lens used with a high resolution camera is used to accurately determine the azimuth of an instrument by measuring the position of celestial targets. During the day, the image of the sun or moon can be used, along with the observer's precise time, latitude, longitude. At nighttime, the moon, bright stars, or planets can be used. Measurements of celestial objects are known to very high precision, so the azimuth precision is limited mainly by the precision of the optics used to view them. The best instrument will depend on the time of measurement—day or night. Fully automatic operation requires that the imaged targets are identified. Based on the shape, brightness, and the time of day, the sun or moon is easily identified. In the case of stars, pattern recognition software is required to identify the stars based on their relative spacing. Once the target is identified, additional software determines the orientation of the camera. Celestial navigation software is well known that performs this function.

### BRIEF DESCRIPTION OF THE DRAWINGS

FIG. 1 shows a preferred embodiment of the present invention.

FIGS. 1A and 1B show features of the above embodiment.

### DETAILED DESCRIPTION OF PREFERRED EMBODIMENTS

### First Preferred Embodiment

### Location of Celestial Objects

The Celestial Compass

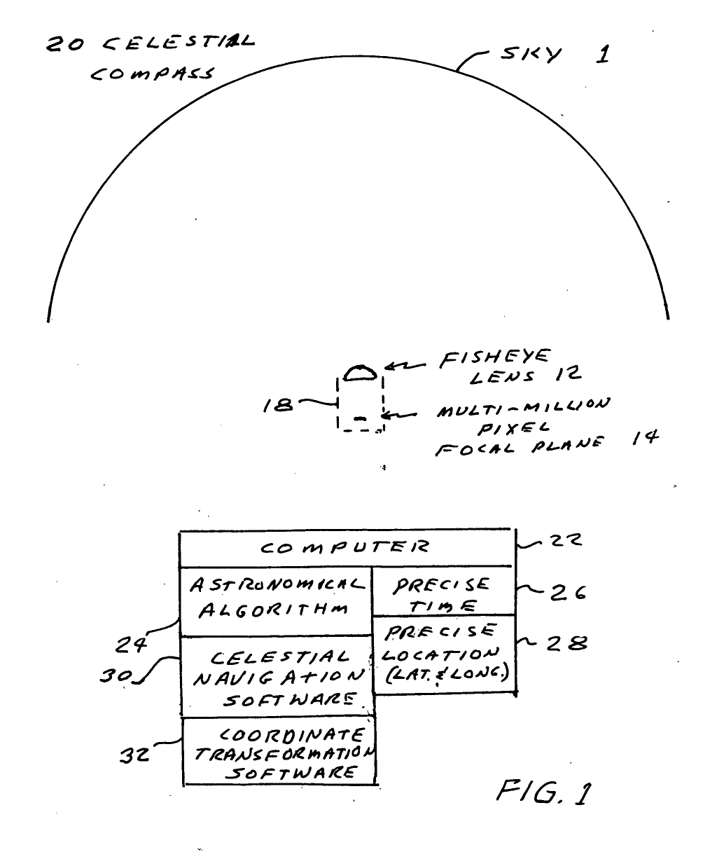

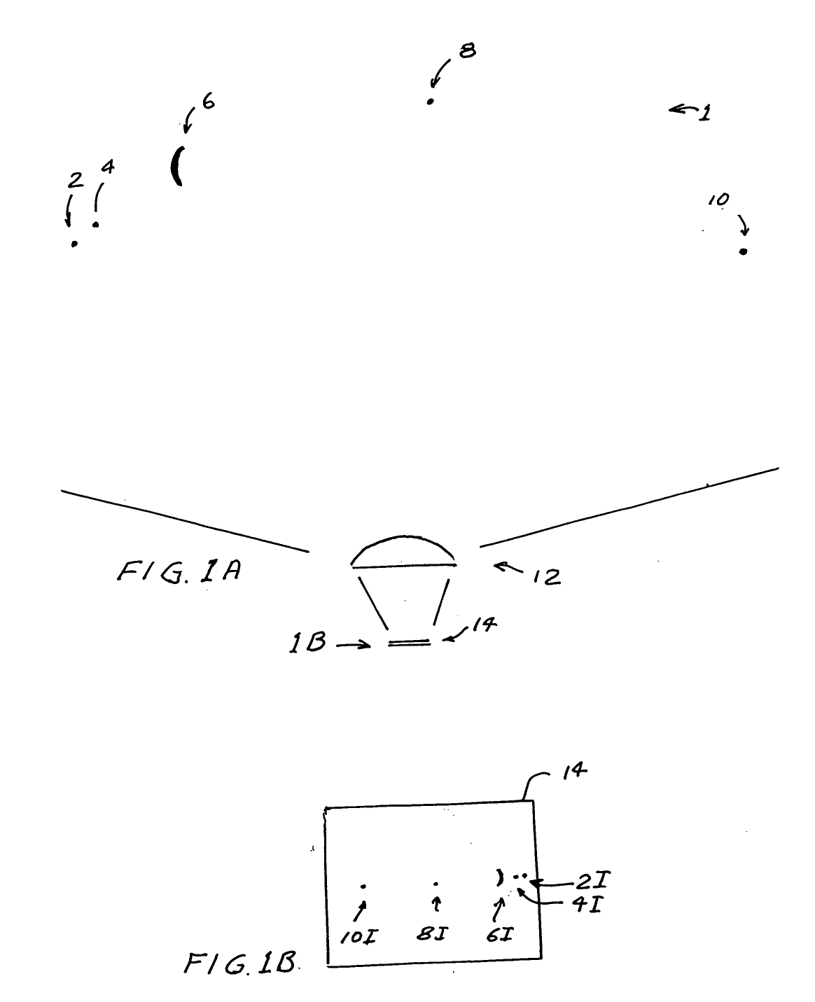

A first preferred embodiment of the present invention is shown in FIG. 1. It is a celestial compass and includes a camera 18 having a fisheye lens 12 suitable for viewing almost an entire hemisphere of the sky and a 6-million pixel sensor for collecting images of celestial objects such as stars, planets, the moon and the sun. The compass also includes a computer 22 programmed with an astronomical algorithm for providing the precise position of celestial objects based on precise input of time (date and time of day) and observation position (latitude and longitude), celestial navigation software 30 and coordinate transformation software 32 for converting pixel image data into astronomical coordinates. Also shown at 26 and 28 is the requirement for the precise time and location information.

The Camera

As shown in FIG. 1A about 170 degrees of a nighttime hemisphere 1 is viewed via a camera 18 with a fisheye lens 12 and a 6-million pixel sensor 14 at the focal plane of the camera. Applicants in their prototype used a Nikon fisheye 10.5 mm F/2.8 camera lens with a 3.75 mm aperture and a 6-million SBIG large format camera. Shown in the nighttime hemisphere are the moon 6 and four stars 2, 4, 8 and 10. The moon and the stars are shown in a portion of the 6-million pixel image of the hemispheres in FIG. 1B at 6I, 2I, 4I, 8I, and 10I, respectively. In tests with a prototype setup built by Applicants, first magnitude stars saturated the CCD camera in 10 seconds with F/8 images and a 1.3 aperture and 4^{th} magnitude stars were bearly visible with the 10-second exposure. In the demonstrations, a green filter was used to reduce lens chromatic aberration. Image diameters ranged from 1.8 mrad to 2.9 mrad for fields of 0, 40, 62 and 80 degrees. The centroid error on a single stellar image is less than 1 mrad. A solar image spans 13 pixels. Preferably an edge detection algorithm should be included in the computer software for precise location of the centroids of the sun and the moon.

Positions of celestial objects are known to very high precision, so the azimuth precision is limited mainly by the precision of the optics used to view them. A fisheye lens, can view nearly an entire hemisphere. If such a lens is attached to a camera that is looking precisely in the vertical direction, then the sun, the moon, or some bright stars or planets will nearly always be visible. The image formed by the lens will be captured by a high resolution digital camera, so that the location of the celestial target can be determined to high accuracy. In a test by Applicants, a 10.5 mm focal length lens connected to a camera with approximately six million pixels was able to provide target location accuracy more precise than 1/20th degree. Each pixel measured about 1/20th of a degree, and stars measured about 2 pixels across, due to imperfections in the lens. Determining the target centroid to less than one half of its diameter is possible if the signal to noise ratio is high enough. For bright celestial targets, this is normally true.

### Correct for Camera Distortion

Converting the pixel location to celestial altitude is performed by measuring the distortion in the camera and using a pixel scale factor in degrees per pixel. To determine the accurate celestial location of a small target requires only a centroid measurement. To determine the accurate celestial location of the sun or moon requires finding the edges of the target and then calculating the true center based on the size and shape of the target at the time of the observation. The software for this conversion of image data into astronomical coordinates is shown in FIG. 1 at 32. The software as indicated above must correct for the distortion of the wide angle lens while also converting image data into astronomical coordinates, preferably elevation and azimuth.

### Identification of Celestial Objects

To make an azimuthal determination an operator of the device shown in FIGS. 1A and 1B may pick a celestial object with which he is familiar such as the moon or a bright star that he recognizes. Preferably, however the system is programmed with a star pattern recognition program so that the system computer is programmed with the ability to recognize bright stars and to automatically calculate the azimuth of the system from the positions of the stars. Based on the shape, brightness, and the time of day, the computer can be easily programmed to recognize the sun and moon. In the case of stars, pattern recognition software may be used to identify the stars based on their relative spacing. Once the target is identified, additional software determines the orientation of the camera. Astronomical algorithms and celestial navigation software suitable for programming computer 22 is described and provided in several well-known texts including Astronomical Algorithms by Jean Meeus that is referred to in the Background Section. Once the camera orientation is known, the azimuth of the instrument is known.

### Boresighting Other Instruments

Boresighting the camera with other optical instruments requires a single calibration. A target at a known azimuth is imaged by the other optical instruments at the same time that a celestial measurement is made. The azimuth reported by the celestial measurements is then rotated to agree with the other optical instruments. With elevation and azimuth determined by

### Daytime Use

During the day, the image of the sun or moon can be used, along with the observer's precise time, latitude, longitude.

### Second Preferred Embodiment

### Observation of Celestial Arcs

An alternate design uses the same wide angle lens and camera, but slightly different software. If the instrument is stationary for a period of time, for example a few minutes, then target identification is not required. The motion of any celestial target over a short period will describe an arc across the sky. The arcs that are directly North or South of the observer will be horizontal and parallel to the horizon, but travel in opposite directions. Arcs directly East or West will be vertical to some extent, depending on the observer's latitude. By calculating the arc's direction, the target does not need to be identified. This allows the instrument to calculate its orientation based on only a single unidentified star at night.

There are many variations to the above specific embodiments of the present invention. Many of these will be obvious to those skilled in the art. For example in many embodiments focal plane arrays with only 4 million pixels will be adequate. So the scope of the present invention should be determined by the appended claims and their legal equivalence.

What is claimed is:

1. A celestial compass comprising of:
A) a camera for viewing a large portion of sky, said camera comprising:
1) a very wide angle lens and
2) a sensor having a focal plane array of at least 4 million pixels;
B) a computer programmed with:
1) an astronomical algorithm for defining locations of celestial objects based on precise time and observation location,
2) celestial navigation software, and
3) coordinate transformation software for converting pixel image software into astronomical coordinates;
C) a timing means for input of precise time including date and time of day; and
D) a location means for input of precise location of said camera.

2. The compass as in claim 1 wherein the very wide angle lens is a fisheye lens.

3. The compass as in claim 1 wherein said precise location is provided in terms of latitude and longitude.

4. The compass as in claim 1 wherein said timing means is accurate to within about 5 seconds.

5. The compass as in claim 1 wherein said astronomical coordinates are elevation and azimuth.

6. The compass as in claim 1 wherein said computer is programmed with an algorithm for converting arcs produced over a period of time of more five minutes by a single unknown celestial object into elevation an azimuth.
